(19) United States
(12) Patent Application Publication
(10) Pub. No.: US 2017/0311389 A1
(43) Pub. Date: Oct. 26, 2017

(54) Heated Computer Case

(71) Applicants: James M. Anderson, JR., Chillicothe, IL (US); Michele Anderson, Chillicothe, IL (US)

(72) Inventors: James M. Anderson, JR., Chillicothe, IL (US); Michele Anderson, Chillicothe, IL (US)

(21) Appl. No.: 15/137,874

(22) Filed: Apr. 25, 2016

(51) Int. Cl. H05B 3/36; G06F 1/16; H05B 1/02; H05B 3/00

(52) U.S. Cl. CPC H05B 3/36; H05B 3/0014; G06F 1/1656; H05B 1/0202

(57) ABSTRACT

A heated case for protecting a laptop computer or other portable electronic device from damage that may be caused by cold ambient conditions. The case may be a laptop sleeve or a multi-compartment case including a compartment adapted to receive and contain a laptop computer. A heating element formed of resistive wires is disposed about the sleeve or laptop compartment. A thermostatic control unit controls the temperature. The heating element may draw electric power from a battery or a vehicle via a power cable connected to a power outlet in the vehicle.

### FIELD OF THE INVENTION

The present invention relates to cases for laptop computers, tablets and other portable electronic devices, and more particularly to heated sleeves and cases for use with such devices under cold weather conditions.

### BACKGROUND

The use of laptop computers, tablet computers, smart phones and other portable electronic devices has become widespread in recent years. These devices are often used away from the user's home or office, including in vehicles and on job sites. For example, a property inspector may use a laptop to enter information and generate reports onsite at a home or other building, or a contractor may use a tablet at a construction site to review plans or communicate by email or text. The device may be used outdoors, or used or kept in a vehicle for an extended period of time. As a result, the device may at times be exposed to cold temperatures.

Cold weather can damage a laptop or similar device in multiple ways, from disabling the display and corrupting the hard drive to shattering the screen if it is warmed up too quickly. Both using and storing a laptop in a cold environment can cause problems. Computer manufacturers typically specify an operating temperature range of about 50° to 95° F. (10° to 35° C.). It is therefore generally advised that a laptop should be stored indoors in temperature-controlled climates whenever possible. It should not be left in a vehicle or other places where it will be exposed to extreme cold, even if it is in its case. The screen is especially vulnerable to damage, and a liquid crystal display can freeze if exposed to cold temperatures for too long. While this in itself may not ruin the screen, attempting to use a laptop after it has been in the cold for too long can cause dead pixels or even cause the screen to shatter. Cold temperatures may also significantly reduce battery life.

It is, of course, possible to provide some protection against the cold by keeping the laptop in a case, but this will not by itself be sufficient in extremely cold conditions. Further, even with a case, a laptop may still be susceptible to moisture damage, including condensation that may occur when the device is warmed up.

A need therefore exists for a temperature-controlled case for a laptop or other portable electronic device, which provides an appropriate level of heat to protect the device from cold ambient conditions.

### SUMMARY OF THE INVENTION

In accordance with the invention, a temperature controlled case for a portable electronic device comprises a compartment adapted to receive and contain a portable electronic device, a heating element disposed about the compartment, a thermostatic control unit operably connected to the heating element, and means for connecting the control unit to an electric power source.

In one aspect of the invention, the case is a sleeve for a laptop computer.

In another aspect of the invention, the case includes a bottom panel, left and right end walls extending upwardly from respective ends of the bottom panel, and front and rear walls extending upwardly from respective sides of the bottom panel and extending between the left and right end walls. The bottom, left and right end walls, and front and rear walls define at least one compartment, and a heating element is disposed on at least one of the walls which define the compartment.

In another aspect of the invention, the case includes a number of compartments, at least one of which is adapted to receive and contain a laptop computer. The case may include interior and exterior storage pockets.

In another aspect of the invention, the power source is a vehicle and a power cable having a plug adapted for connection to a cigarette lighter or power outlet in the vehicle is provided. The case may include a pocket on the exterior of the case for storing the power cable when not in use.

In another aspect of the invention, the power source is a battery.

In another aspect of the invention, the control unit is preset to a predetermined temperature. Alternately, the control unit includes means for adjusting the temperature to a desired temperature, and may include a display of the selected temperature.

### BRIEF DESCRIPTION OF THE DRAWINGS

FIG. 1 is a perspective view of a heated laptop computer sleeve-type case in accordance with the invention.

FIG. 2 is a perspective view of an alternate embodiment of a heated laptop computer case in accordance with the invention.

FIG. 3 is a perspective view showing the interior compartments of the case of FIG. 2.

FIG. 4 is a view of interior storage pockets of the case of FIG. 2.

FIG. 5 is a perspective view of the case of FIG. 2 showing details of the heating elements in accordance with the invention.

### DETAILED DESCRIPTION OF THE INVENTION

The case of the invention may take a variety of forms and configurations, and the size may be varied to accommodate particular portable electronic devices. Two illustrative embodiments will be described with reference to the figures.

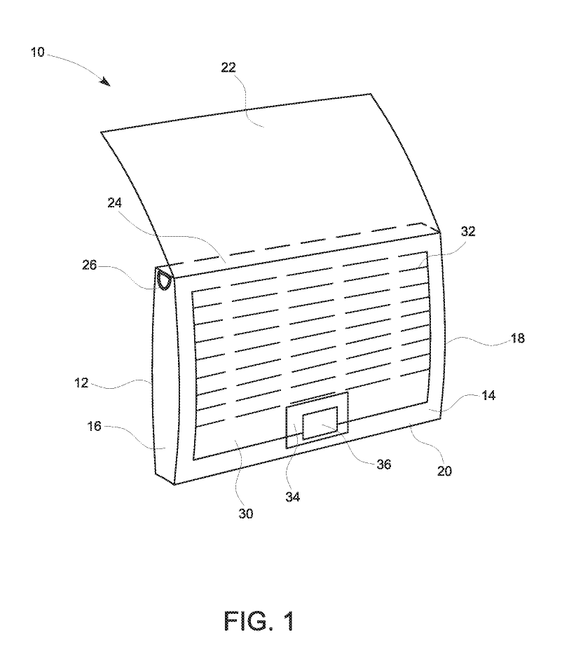

A laptop sleeve 10 is show in FIG. 1. Sleeve 10 includes a front wall 12, a rear wall 14, left and right end walls 16 and 18, bottom panel 20 and top 22. Front wall 12, rear wall 14, end walls 16, 18, and bottom panel 20 generally define and form a compartment 24 configured to receive and contain a laptop computer or other portable electronic device.

Top 22 is attached in a hinge arrangement to the upper edge of rear wall 14. Top 22 forms a flap, so that when top 22 is closed, a portion extends between front wall 12 and rear wall 14, and the rest extends down over part of front wall 12, where it may be secured in a closed position by hook-and-loop fasteners or a clasp (not shown). Top 22 may be fully opened to permit easy insertion and removal of the laptop computer.

Metal or plastic D-rings 26 are preferably attached at the top of end walls 16, 18. A shoulder strap (not shown) may be attached to D-rings 26 with snaps or hooks.

Front wall 12, rear wall 14, end walls 16, 18, bottom panel 20 and top 22 are constructed of fabric material of a type commonly used for luggage, such as ballistic or Cordura nylon, polyester or canvas. Such materials are strong, durable and attractive. Bottom panel 20 may include a stiffener (not shown) either inside sleeve 10 or encased in fabric. The stiffener may be made of a rigid plastic, e.g., ABS. Other walls may include stiffeners, if desired.

Preferably, compartment 24 is padded to provide protection for the laptop. The padding material, which may be for example foam or fabric, may be located inside sleeve 10 or may be encased in the fabric used for the walls of sleeve 10.

The size of sleeve 10 may be varied to accommodate particular devices. For a standard laptop computer, sleeve 10 is preferably about 17.5 inches (44.5 cm) long, 12 inches (30.5 cm) high and 1.5 inches (4 cm) wide.

Heating element 30 consists of a network of insulated resistive wires 32. Wires 32 are preferably located between an outer fabric layer and an inner fabric layer of rear wall 14 as shown in FIG. 1. Alternately, heating element 30 may be located in front wall 12, or heating elements may be provided in both front wall 12 and rear wall 14 to provide heat for both the battery side and the display side of the laptop computer.

Resistive wires 32 may be in the form of a rope heater, namely, a heating element consisting of a very fine electric conductor wire wound around a core which is typically made of glass fibers. Wires 32 may be stitched or otherwise attached either directly to one of the layers of a wall of sleeve 10 or onto a substrate made of felt or similar material which is then sandwiched between fabric layers forming the wall. The substrate bearing the heating element may be covered by a pair of vinyl sheets, one on each side of the felt, with the vinyl sheets being adhered together by adhesive or heat sealing at their peripheral edges to provide a water tight enclosure. Alternately, the entire heating element 30 may be covered by an insulating layer of PVC to prevent contact with the electrically live wire. The rope heater is typically of a diameter of about one eighth (⅛″) of an inch.

As an alternative to wires 32, heating element 30 may be in the form of a flexible, electrically-conductive sheet or other suitable type of heating device.

Heating element 30 is connected to a thermostatic control unit 34, which may be located at any convenient position on or in sleeve 10. Control unit 34 senses the temperature in compartment 24 and varies the amount of current through wires 32 to vary the amount of heat generated and thus control the temperature in compartment 24. The desired temperature may be preset and fixed, or a controller may be provided to allow a user to adjust the temperature setting manually. The controller may be a simple rheostat with a rotatable knob or an up-and-down switch with or without a temperature display. If the temperature is preset and fixed, the temperature should not be less than the lower limit of the operating range for the laptop computer, i.e., about 50° F. (10° C.). If the temperature is adjustable, the controller may permit adjustment in a range from the lower limit of the laptop computer's operating range to roughly normal room temperature, e.g., about 50° to 75° F. (10° to 24° C.). Control unit 34 may also be programmed with an upper temperature limit which cannot be exceeded, to prevent damage to the laptop computer that might be caused by overheating.

Heating element 30 and control unit 34 are connected to a power source, which may be a battery pack, either external or located in sleeve 10, or an external power source such as a vehicle. A pocket 36 is preferably provided on sleeve 10 for storing a power cord for connection to the power source.

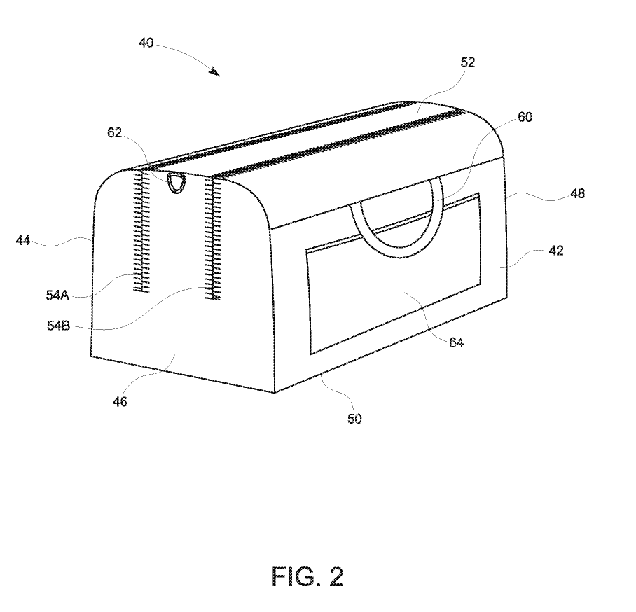

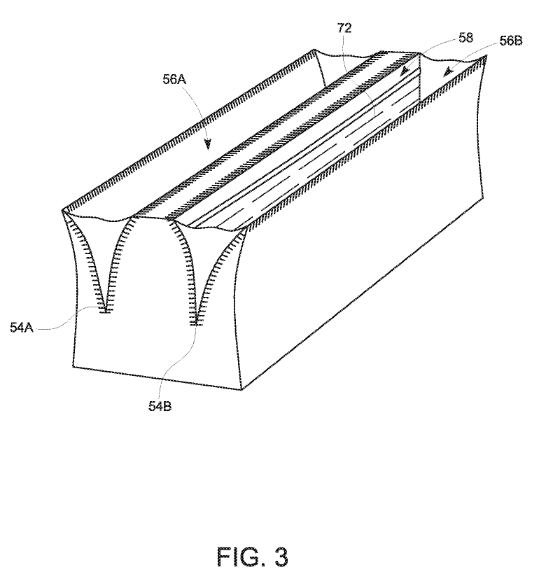

An alternative embodiment of the invention is shown in FIGS. 2-5. Case 40 includes front wall 42, rear wall 44, left and right end walls 46 and 48, bottom panel 50 and top panel 52. A pair of zippers 54A and 54B are provided in top panel 52, running the length of top panel 52 and extending partially down end walls 46 and 48. As shown in FIG. 3, when zippers 54A, 54B are opened, two compartments 56A, 56B are made accessible and expand when opened. An interior center compartment 58 is provided inside compartment 56B for receiving and containing a laptop computer or other electronic device. Padding is provided on both sides of center compartment 58 to protect the laptop computer. Center compartment 58 may optionally include a suspended cradle to protect the laptop computer against shock and impact.

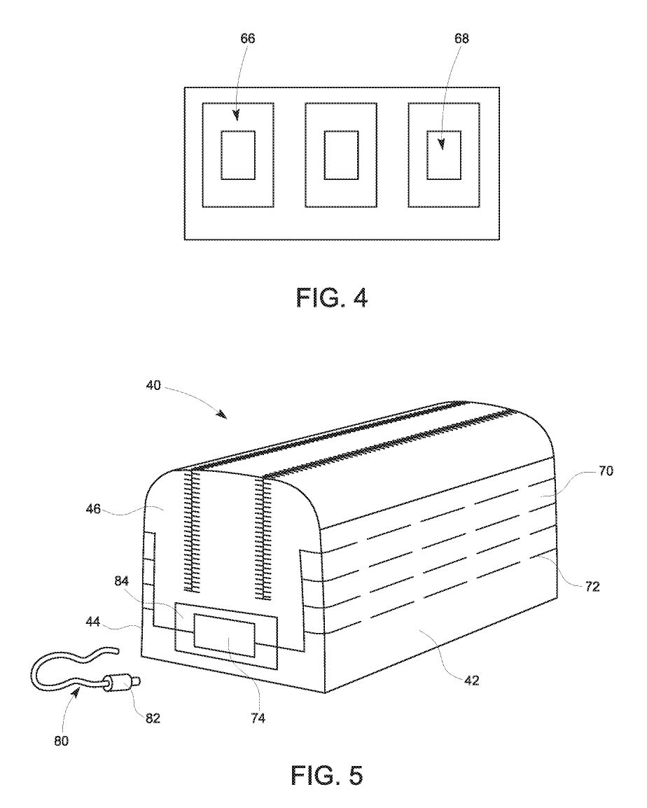

Handles 60 are attached on both sides of case 40. A pair of D-rings 62 are attached at the top of end walls 46, 48 to permit attachment of a shoulder strap. Exterior pockets 64 are provided on front wall 42 and rear wall 44. As shown in FIG. 4, large and small pockets 66 and 68, respectively, are preferably provided inside side compartments 56A, 56B. One or more of pockets 66, 68 may have zipper or hook-and-loop closures.

The size of case 40 and center compartment 58 may be varied to accommodate particular electronic devices. For a standard laptop computer, case 40 is preferably about 17.5 inches (44.5 cm) long, 14 inches (35.5 cm) high and 7 inches (18 cm) wide.

Heating element 70 consists of a network of insulated resistive wires 72 which are located between fabric layers which form the walls of center compartment 58 as shown in FIG. 3. As previously described, wires 72 may be stitched or otherwise attached either directly to one of the layers of the walls or onto a substrate made of felt or similar material which is then sandwiched between fabric layers of the walls. Heating element 70 may also be sealed in PVC as described above.

In an alternative embodiment shown in FIG. 5, heating element 70 may be located between an outer fabric layer and an inner fabric layer of front wall 42 and rear wall 44 of case 40, instead of, or in addition to, being provided in the walls of center compartment 58.

Heating element 70 is connected to a thermostatic control unit 74, which is preferably located on one end wall of case 40 as shown in FIG. 5, but may be located at any convenient position on or in case 40. The desired temperature may be preset and fixed, or a controller may be provided to allow a user to adjust the temperature setting manually, as described above.

In the case of using a vehicle as the power source, a power cable 80 with a plug 82 for insertion in a cigarette lighter or other vehicle power outlet is provided. Cable 80 may be permanently connected to control unit 74, or may be provided with a plug for connection to a power jack on case 40. A pocket 84 may be provided on case 40 for convenient storage of power cord 80. If a battery pack is provided, it may be charged while power cord 80 is connected to a vehicle power source.

The manners of use of both sleeve 10 and case 40 are similar. The user simply places the laptop or other electronic device in compartment 24 of sleeve 10 or center compartment 58 of case 40, connects the power source (battery or power cable 80 connected to a vehicle), and adjusts the temperature setting as appropriate using control unit 34 or 74. Heating element 30 or 70 will be thermostatically activated as necessary to maintain a desired temperature in compartment 24 of sleeve 10 or center compartment 58 of case 40, thus protecting the laptop computer from exposure to extreme cold.

While the invention has been described with respect to certain embodiments, as will be appreciated by those skilled in the art, it is to be understood that the invention is capable of numerous changes, modifications and rearrangements, and such changes, modifications and rearrangements are intended to be covered by the following claims.

What is claimed is:

1. A temperature controlled case for a portable electronic device comprising:
a compartment adapted to receive and contain a portable electronic device;
a heating element disposed about the compartment;
a thermostatic control unit operably connected to the heating element; and
means for connecting the control unit to an electric power source.

2. The case of claim 1 wherein the case is a sleeve adapted to receive and contain a laptop computer.

3. The case of claim 1 comprising:
a bottom panel,
left and right end walls extending upwardly from respective ends of the bottom panel,
front and rear walls extending upwardly from respective sides of the bottom panel and extending between the left and right end walls,
whereby the bottom, left and right end walls, and front and rear walls define at least one compartment, and
wherein the heating element is disposed on at least one of the walls which define the compartment.

4. The case of claim 3 wherein the heating element comprises a plurality of resistive wires.

5. The case of claim 4 wherein the wires are attached to the at least one of the walls.

6. The case of claim 4 wherein the wires are attached to a substrate and the substrate is attached to the at least one of the walls.

7. The case of claim 6 wherein the substrate is encased in a water-resistant material.

8. The case of claim 3 further comprising a top hingedly attached to the top of the rear wall and releaseably attached to the front wall.

9. The case of claim 1 further comprising a plurality of interior compartments.

10. The case of claim 9 further comprising interior pockets in one or more of the interior compartments.

11. The case of claim 1 wherein the power source is a vehicle and the means for connecting is a power cable having a plug adapted for connection to a cigarette lighter or power outlet in the vehicle.

12. The case of claim 11 further comprising a pocket on the exterior of the case adapted for storing the power cable when not in use.

13. The case of claim 1 wherein the power source is a battery.

14. The case of claim 1 wherein the control unit is preset to maintain a predetermined temperature in the compartment.

15. The case of claim 14 wherein the predetermined temperature is about 50° F. (10° C.).

16. The case of claim 1 wherein the control unit comprises means for adjusting the temperature to a desired temperature.

17. The case of claim 16 wherein the control unit comprises means for displaying the set temperature.

18. The case of claim 16 wherein the control unit is configured to adjust the temperature in a range from about 50° F. (10° C.) to about 75° F. (24° C.).
